(19) United States
(12) Patent Application Publication
(10) Pub. No.: US 2025/0029376 A1
(43) Pub. Date: Jan. 23, 2025

(54) MEDICAL HYPERSPECTRAL IMAGE (MHSI) CLASSIFICATION METHOD BASED ON FAST FULLY CONVOLUTIONAL NETWORK (FCN)

(71) Applicant: Shandong University, Jinan City (CN)

(72) Inventors: Xiaopeng MA, Jinan City (CN); Shenshen ZHANG, Jinan City (CN); Chenglong ZHANG, Jinan City (CN); Xiaoli YANG, Jinan City (CN); Dexin YU, Jinan City (CN)

(21) Appl. No.: 18/437,054

(22) Filed: Feb. 8, 2024

(30) Foreign Application Priority Data
Jul. 17, 2023 (CN) 202310871727.6

(51) Int. Cl. G06V 10/82; G06V 10/30; G06V 10/764; G06V 10/77; G06V 10/774; G06V 10/776; G06V 20/50

(52) U.S. Cl. CPC G06V 10/82; G06V 10/30; G06V 10/764; G06V 10/7715; G06V 10/774; G06V 10/776; G06V 20/50; G06V 2201/03

(57) ABSTRACT

The present disclosure provides a medical hyperspectral image (MHSI) classification method based on a fast fully convolutional network (FCN), and relates to the technical field of MHSIs. The MHSI classification method includes: preprocessing and sampling an MHSI to obtain a training sample set; inputting the training sample set into an encoder-decoder-based FCN to train the MHSI; and inputting a to-be-classified pixel of the MHSI into a trained encoder-decoder-based FCN to obtain a classification result. The present disclosure provides the MHSI classification method based on a fast FCN. In order to resolve problems of low efficiency and insufficient performance of an existing MHSI classification method, the present disclosure designs a classification method based on the fast FCN, which avoids redundant computation in an overlapping region between image patches, greatly improving an inference speed.

### CROSS REFERENCE TO RELATED APPLICATION

This application claims the benefit of and priority to Chinese Patent Application No. 202310871727.6, filed with the Chinese Patent Office on Jul. 17, 2023, which is hereby incorporated by reference herein in its entirety.

### TECHNICAL FIELD

The present disclosure relates to the technical field of medical hyperspectral images (MHSIs), and specifically, to an MHSI classification method based on a fast fully convolutional network (FCN).

### BACKGROUND

Compared with a traditional color digital image, a hyperspectral image (HSI) has higher spectral resolution, typically containing tens to hundreds of wavebands. Rich spectral information can provide a basis for accurately identifying a target. Therefore, the HSI is widely used in the field of remote sensing. With the advancement of science and technology, advantages of spectral imaging have been applied in various fields, for example, archaeological mural protection, physical evidence identification, and non-destructive testing of food. With the continuous development of the medical spectral imaging technology, medical health has become a fastest-growing application field of the HSI. For medical applications, a medical hyperspectral image (MHSI) can not only provide two-dimensional spatial distribution information of various tissue structures, but also obtain a complete spectrum of a point on a biological tissue sample in an interested wavelength range to analyze chemical compositions and physical characteristics of different pathological tissues. Therefore, rapid and accurate MHSI classification makes it possible to perform non-invasive disease diagnosis and achieve clinical treatment applications.

MHSI classification is to allocate a semantic label to a pixel based on a feature of an image. In early research on HSI classification, some classifiers based on spectral information such as a support vector machine (SVM) classifier, a random forest (RF) classifier, and a multinomial logistic regression (MLR) classifier have achieved certain success. In recent years, in order to make full use of a spatial feature of the HSI, many classification methods based on spatial-spectral features, such as joint sparse representation (JSR) classification, joint nearest neighbor (JNN) classification, and joint collaborative representation (JCR) classification, have obtained high-precision classification results based on spatial neighborhood information of the pixel. In addition, in order to automatically obtain a more general spectral-spatial feature, the deep learning technology is currently introduced into the HSI classification as a data-driven automatic feature learning framework. As a hierarchical spectral-spatial feature representation learning framework, Convolutional Neural Networks (CNN) has been widely applied in the HSI classification, and has significantly improved accuracy compared with traditional methods.

However, due to lack of utilization of spatial contextual information, a classification method based on the spectral information often results in a large number of noise spots in a classification result, making it difficult to meet an application demand of the HSI. For an ultra-complex surface, especially when a to-be-classified pixel is in a heterogeneous region, distinguishing performance of a current method based on spatial-spectral information fusion is degraded due to interference from a heterogeneous pixel, and this type of method usually requires longer computation time due to the spatial-spectral information fusion. The CNN-based methods follows a patch-based local learning framework, which can cause redundant computation due to overlapping of image patches of adjacent pixels, thereby limiting an operation speed of the CNN-based method. In addition, a size of the image patch is much smaller than a size of an entire image. As a result, only some local features can be extracted, thereby limiting classification performance.

Therefore, in view of the shortcomings of the existing CNN-based classification methods, how to improve computational efficiency of an MHSI classification method has become an urgent problem to be resolved.

### SUMMARY

In view of this, embodiments of the present disclosure provide an MHSI classification method based on a fast FCN to resolve a problem that a prior-art MHSI classification method following a patch-based local learning framework has redundant computation and low computational efficiency due to overlapping of image patches of adjacent pixels.

An embodiment of the present disclosure provides an MHSI classification method based on a fast FCN, including:
a) preprocessing and sampling an MHSI to obtain a training sample set;
b) inputting the training sample set into an encoder-decoder-based FCN to train the MHSI; and
c) inputting a to-be-classified pixel of the MHSI into a trained encoder-decoder-based FCN to obtain a classification result.

Optionally, the MHSI classification method further includes:
a) sampling a test sample for the MHSI; and
b) evaluating classification accuracy of the classification result based on the test sample.

Optionally, the preprocessing and sampling an MHSI to obtain a training sample set includes:
a) de-noising the MHSI by using a two-dimensional singular spectrum analysis (SSA) method.

Optionally, the inputting the training sample set into an encoder-decoder-based FCN to train the MHSI includes:
a) converting the training sample set into a fixed quantity of channel outputs by using a backbone block;
b) sampling the training sample set by using a first hybrid block, to obtain a plurality of first eigenvalues; performing one-dimensional convolution on the first eigenvalues once to obtain a first one-dimensional convolution result; and performing two-dimensional convolution on the first one-dimensional convolution result once to obtain a first two-dimensional convolution result;
c) sampling the first two-dimensional convolution result by using a second hybrid block, to obtain a plurality of second eigenvalues; performing one-dimensional convolution on the second eigenvalues once to obtain a second one-dimensional convolution result; and performing two-dimensional convolution on the second one-dimensional convolution result once to obtain a second two-dimensional convolution result;
d) sampling the second two-dimensional convolution result by using a third hybrid block, to obtain a plurality of third eigenvalues; performing one-dimensional convolution on the third eigenvalues once to obtain a third one-dimensional convolution result; and performing two-dimensional convolution on the third one-dimensional convolution result once to obtain a third two-dimensional convolution result;
e) performing one-dimensional convolution on the third two-dimensional convolution result once by using a fourth hybrid block, to obtain a fourth one-dimensional convolution result; and performing two-dimensional convolution on the fourth one-dimensional convolution result once to obtain a fourth two-dimensional convolution result;
f) aggregating the first two-dimensional convolution result, the second two-dimensional convolution result, the third two-dimensional convolution result, and the fourth two-dimensional convolution result by using a decoder network, to restore a spatial detail of the input training sample set;
g) performing, by using a head subnetwork, pixel classification on a top-level feature aggregated by the decoder network to obtain a training classification result;
h) calculating a loss function for the training classification result; and
i) updating a weight of the encoder-decoder-based FCN through backpropagation based on the loss function; where
j) the first hybrid block, the second hybrid block, the third hybrid block, and the fourth hybrid block perform convolution calculation by using a convolutional block attention module (CBAM).

Optionally, the MHSI classification method further includes:
a) connecting a first refinement module of the decoder network to the fourth hybrid block through a first convolutional layer of lateral connection-based semantic-spatial fusion (SSF) to transmit the fourth convolution result to an encoder network;
b) connecting a second refinement module of the decoder network to the third hybrid block through a second convolutional layer of the lateral connection-based SSF to transmit the third convolution result to the encoder network;
c) connecting a third refinement module of the decoder network to the second hybrid block through a third convolutional layer of the lateral connection-based SSF to transmit the second convolution result to the encoder network; and
d) connecting the head subnetwork of the decoder network to the first hybrid block through a fourth convolutional layer of the lateral connection-based SSF to transmit the first convolution result to the encoder network.

Optionally, the calculating a loss function for the training classification result includes:
a) minimizing the loss function of the training classification result by using a stochastic gradient descent method.

Optionally, the aggregating the first two-dimensional convolution result, the second two-dimensional convolution result, the third two-dimensional convolution result, and the fourth two-dimensional convolution result by using a decoder network, to restore a spatial detail of the input training sample set includes:
a) connecting the first refinement module and the second refinement module through a first upsampling module to aggregate the fourth two-dimensional convolution result and the third two-dimensional convolution result;
b) connecting the second refinement module and the third refinement module through a second upsampling module to aggregate the fourth two-dimensional convolution result, the third two-dimensional convolution result, and the second two-dimensional convolution result; and
c) connecting the third refinement module and the head subnetwork through a third upsampling module to aggregate the fourth two-dimensional convolution result, the third two-dimensional convolution result, the second two-dimensional convolution result, and the first two-dimensional convolution result.

Optionally, the head subnetwork is constituted by a 3×3 convolutional layer and a 1×1 convolutional layer with N filters, where N is a quantity of categories.

Optionally, the updating a weight of the encoder-decoder-based FCN through backpropagation based on the loss function includes:
a) for an i^{th} iteration, updating a k^{th} weight of the encoder-decoder-based FCN as follows:

$${ω}_{i + 1}^{( k )} = {ω}_{i}^{( k )} - η \frac{1}{n} {\sum }_{p ∈ {R}_{i}} \frac{\partial l ( {\tilde{Y}}_{l} ( p ) , {\hat{Y}}_{l} ( p ) )}{\partial {ω}_{i}^{( k )}} ; \\ {\hat{Y}}_{l} = {f}^{*} ( X ) ;$$

where p represents a two-dimensional spatial location in Rᵢ; n=|Rᵢ|; η represents a learning rate; l represents a classification loss; \tilde{Y}ₗ represents a ground truth of a sampled HSI; Ŷₗ represents a predicted picture; a mapping f*:R^{C×H×W}→R^{#class×H×W} represents a patch-free model; and C represents a quantity of frequency bands of an input X.

Optionally, the convolutional layer of the lateral connection-based SSF is as follows:

$${q}_{j + 1} = {q}_{j} + conv ( {p}_{4 - j} ) ;$$

where qⱼ represents a feature mapping of a #j refinement stage in a decoder; p₄₋ⱼ represents a feature mapping of a #4-j hybrid block in an encoder; qⱼ₊₁ represents an output of a convolutional layer of SSF; and j=1, 2, 3.

The embodiments of the present disclosure have following beneficial effects. First, the embodiments of the present disclosure provide an MHSI classification method based on a fast FCN. In order to resolve problems of low efficiency and insufficient performance of an existing MHSI classification method, the present disclosure designs a classification method based on the fast FCN, which avoids redundant computation in an overlapping region between image patches, greatly improving the inference speed.

Second, through the FCN networks based on Convolutional Attention Module (CBAM) and lateral connection-based SSF, a global spatial background and detail are maximally utilized. The CBAM models interdependence of feature mappings under guidance of a global spatial environment. The lateral connection-based SSF utilizes a global spatial detail of a shallow feature to gradually refine a semantic feature, and adopts a residual learning method to fuse features by pointwise addition, thereby alleviating a vanishing gradient problem, and jointly significantly improving performance of the FCN.

### BRIEF DESCRIPTION OF THE DRAWINGS

The features and advantages of the present disclosure can be more clearly understood with reference to the accompanying drawings. The accompanying drawings are illustrative and should not be understood as any limitation on the present disclosure. In the accompanying drawings:

FIG. 1 is a flowchart of an MHSI classification method based on a fast FCN according to an embodiment of the present disclosure;

FIG. 2 shows a classification process of a fast FCN according to an embodiment of the present disclosure;

FIG. 3 shows a false color image of a living tissue of a brain cancer according to an embodiment of the present disclosure;

FIG. 4 shows a real label of a living tissue of a brain cancer according to an embodiment of the present disclosure;

FIG. 5 shows a result of SVM classification of a living tissue of a brain cancer according to an embodiment of the present disclosure;

FIG. 6 shows a result of JNN classification of a living tissue of a brain cancer according to an embodiment of the present disclosure;

FIG. 7 shows a result of JSRC classification of a living tissue of a brain cancer according to an embodiment of the present disclosure; and

FIG. 8 shows a result of FCN classification of a living tissue of a brain cancer according to an embodiment of the present disclosure.

### DETAILED DESCRIPTION

In order to make the objectives, technical solutions, and advantages of the embodiments of the present disclosure clearer, the technical solutions in the embodiments of the present disclosure will be clearly and completely described below in conjunction with the accompanying drawings in the embodiments of the present disclosure. Apparently, the described embodiments are some, rather than all of the embodiments of the present disclosure. All other embodiments obtained by those of ordinary skill in the art based on the embodiments of the present disclosure without creative efforts should fall within the protection scope of the present disclosure.

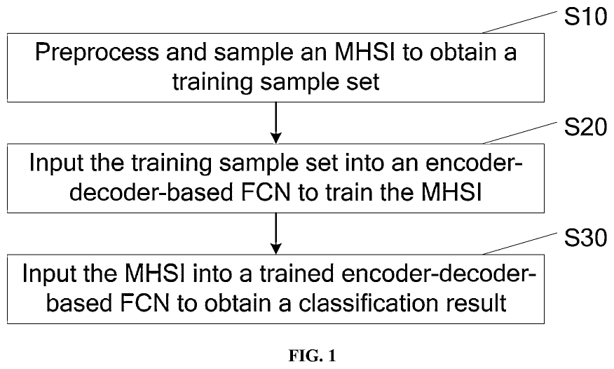

An embodiment of the present disclosure provides an MHSI classification method based on a fast FCN. As shown in FIG. 1, the MHSI classification method includes:
a) Step S10: Preprocess and sample an MHSI to obtain a training sample set.

In this embodiment, the MHSI is de-noised by using a two-dimensional SSA method to improve quality of the input image.

Step S20: Input the training sample set into an encoder-decoder-based FCN to train the MHSI.

In this embodiment, a plurality of training samples are manually selected from a to-be-classified MHSI and input into the encoder-decoder-based FCN to train the to-be-classified MHSI. In a specific embodiment, ten samples are selected, with eight samples as training samples and two samples as test samples.

Step S30: Input a to-be-classified pixel of the MHSI into a trained encoder-decoder-based FCN to obtain a classification result.

In this embodiment, after the trained FCN converges, the to-be-classified MHSI is input into the FCN for one forward operation to achieve HSI classification.

This embodiment of the present disclosure provides an MHSI classification method based on a fast FCN. In order to resolve problems of low efficiency and insufficient performance of an existing MHSI classification method, the present disclosure designs a classification method based on the fast FCN, which avoids redundant computation in an overlapping region between image patches, greatly improving an inference speed.

As an optional implementation, the MHSI classification method further includes:
a) sampling a test sample for the MHSI; and
b) evaluating classification accuracy of the classification result based on the test sample.

In this embodiment, the two test samples in the step S20 are used to evaluate the accuracy of the classification result. A remaining labeled sample for training is used to test and calculate a confusion matrix to obtain overall accuracy (OA) and a Kappa coefficient of classification. In a specific embodiment, classification accuracy and standard deviations of 10 random selections of a training set are recorded.

As an optional implementation, the inputting the training sample set into an encoder-decoder-based FCN to train the MHSI includes:
a) converting the training sample set into a fixed quantity of channel outputs by using a backbone block;
b) sampling the training sample set by using a first hybrid block, to obtain a plurality of first eigenvalues; performing one-dimensional convolution on the first eigenvalues once to obtain a first one-dimensional convolution result; and performing two-dimensional convolution on the first one-dimensional convolution result once to obtain a first two-dimensional convolution result;
c) sampling the first two-dimensional convolution result by using a second hybrid block, to obtain a plurality of second eigenvalues; performing one-dimensional convolution on the second eigenvalues once to obtain a second one-dimensional convolution result; and performing two-dimensional convolution on the second one-dimensional convolution result once to obtain a second two-dimensional convolution result;
d) sampling the second two-dimensional convolution result by using a third hybrid block, to obtain a plurality of third eigenvalues; performing one-dimensional convolution on the third eigenvalues once to obtain a third one-dimensional convolution result; and performing two-dimensional convolution on the third one-dimensional convolution result once to obtain a third two-dimensional convolution result;
e) performing one-dimensional convolution on the third two-dimensional convolution result once by using a fourth hybrid block, to obtain a fourth one-dimensional convolution result; and performing two-dimensional convolution on the fourth one-dimensional convolution result once to obtain a fourth two-dimensional convolution result;
f) aggregating the first two-dimensional convolution result, the second two-dimensional convolution result, the third two-dimensional convolution result, and the fourth two-dimensional convolution result by using a decoder network, to restore a spatial detail of the input training sample set;
g) performing, by using a head subnetwork, pixel classification on a top-level feature aggregated by the decoder network to obtain a training classification result;
h) calculating a loss function for the training classification result; and
i) updating a weight of the encoder-decoder-based FCN through backpropagation based on the loss function.

The first hybrid block, the second hybrid block, the third hybrid block, and the fourth hybrid block perform convolution calculation by using a CBAM.

In this embodiment, a basic module of an encoder network is a 3×3 convolutional layer, which then undergoes group normalization (GN) and rectified linear unit (RELU) activation. Due to different quantities of frequency bands in MHSIs, the backbone block is introduced to convert input variable channels into fixed 64 channels. Then, the four hybrid blocks are introduced. The first three hybrid blocks each are constituted by a spectral attention module, the basic module, and a downsampling module, and the fourth hybrid block is constituted by the spectral attention module and the basic module.

The spectral attention module is a lightweight CBAM, which combines channel and spatial attention mechanisms and can achieve a better result compared with a SENet that focuses on only the channel attention mechanism.

An input feature F∈R^{C*H*W} is first input into a channel attention module for one-dimensional convolution M_{c}∈R^{C*1*1}, and then into a spatial attention module for two-dimensional convolution Mₛ∈R_{1*H*W}. A specific process is as follows:

F″=Mₛ(F)⊗F′;

F″=Mₛ(F)⊗F′;

For the downsampling module, a 3×3 convolutional layer with a step of 2 is used, and then the RELU activation is performed, in order to align a location of a projective space with a center of a receptive field of the projective space, achieving more reliable MHSI classification.

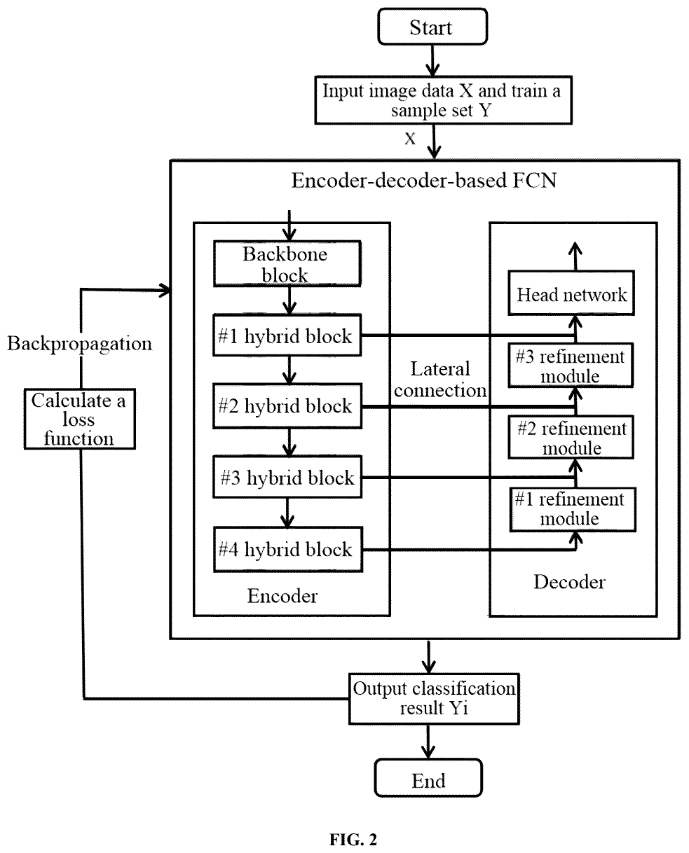

As shown in FIG. 2, a training sample Y is classified to obtain a classification result Yᵢ. A loss function is calculated for the classification result Yᵢ, and the weight of the encoder-decoder-based FCN is updated through the backpropagation. In a specific embodiment, the loss function of the training classification result is minimized by using a stochastic gradient descent method.

As an optional implementation, the MHSI classification method further includes:
a) connecting a first refinement module of the decoder network to the fourth hybrid block through a first convolutional layer of lateral connection-based SSF to transmit the fourth convolution result to the encoder network;
b) connecting a second refinement module of the decoder network to the third hybrid block through a second convolutional layer of the lateral connection-based SSF to transmit the third convolution result to the encoder network;
c) connecting a third refinement module of the decoder network to the second hybrid block through a third convolutional layer of the lateral connection-based SSF to transmit the second convolution result to the encoder network; and
d) connecting the head subnetwork of the decoder network to the first hybrid block through a fourth convolutional layer of the lateral connection-based SSF to transmit the first convolution result to the encoder network.

In this embodiment, the convolutional layer of the lateral connection-based SSF is as follows:

$${q}_{j + 1} = {q}_{j} + conv ( {p}_{4 - j} )$$

In the above formula, qⱼ represents a feature mapping of a #j refinement stage in a decoder; p₄₋ⱼ. represents a feature mapping of a #4-j hybrid block in an encoder; qⱼ₊₁ represents an output of a convolutional layer of SSF; and j=1, 2, 3.

A lateral connection is implemented by a lxi convolutional layer, which transmits an accurate feature location from the encoder to the decoder.

In a specific embodiment, as shown in FIG. 2, a #4 hybrid block transmits the fourth convolution result to a #1 refinement module of the decoder through the lateral connection for detail recovery. A #3 hybrid block transmits the third convolution result to the decoder through the lateral connection, and then inputs the third convolution result together with a fourth convolution result obtained after the detail recovery to a #2 refinement module. A #2 hybrid block transmits the second convolution result to the decoder through the lateral connection, and then inputs the second convolution result together with an output result of the #2 refinement module to a #3 refinement module. A #1 hybrid block transmits the first convolution result to the decoder through the lateral connection, and the head subnetwork performs feature classification on the first convolution result and an output result of the #3 refinement module.

As an optional implementation, the aggregating the first two-dimensional convolution result, the second two-dimensional convolution result, the third two-dimensional convolution result, and the fourth two-dimensional convolution result by using a decoder network, to restore a spatial detail of the input training sample set includes:
a) connecting the first refinement module and the second refinement module through a first upsampling module to aggregate the fourth two-dimensional convolution result and the third two-dimensional convolution result;
b) connecting the second refinement module and the third refinement module through a second upsampling module to aggregate the fourth two-dimensional convolution result, the third two-dimensional convolution result, and the second two-dimensional convolution result; and
c) connecting the third refinement module and the head subnetwork through a third upsampling module to aggregate the fourth two-dimensional convolution result, the third two-dimensional convolution result, the second two-dimensional convolution result, and the first two-dimensional convolution result.

In this embodiment, as shown in FIG. 2, the decoder network also adopts a modular design, which is constituted by the refinement module for progressive spatial feature refinement and the head subnetwork for pixel classification.

In a specific embodiment, the progressive refinement includes two steps: sampling a feature mapping of an input with strong semantic information, and then aggregating a feature mapping of an input with fine spatial information to restore a spatial detail of the input. The refinement module in the decoder network contains a plurality of refinement stages, which can be implemented only by superposing upsampling modules simply and inserting the lateral connection-based SSF after each upsampling module. The upsampling module is constituted by a 3×3 convolutional layer, which undergoes nearest neighbor upsampling with a factor of 2. The head subnetwork is constituted by a 3×3 convolutional layer and a 1×1 convolutional layer with N filters. N is a quantity of categories. The head subnetwork is configured to perform pixel classification on a top-level feature of the decoder.

As an optional implementation, the updating a weight of the encoder-decoder-based FCN through backpropagation based on the loss function includes:
a) for an i^{th} iteration, updating a k^{th} weight of the encoder-decoder-based FCN as follows:

$${ω}_{i + 1}^{( k )} = {ω}_{i}^{( k )} - η \frac{1}{n} {\sum }_{p ∈ {R}_{i}} \frac{\partial l ( {\tilde{Y}}_{l} ( p ) , {\hat{Y}}_{l} ( p ) )}{\partial {ω}_{i}^{( k )}} ; \\ {\hat{Y}}_{l} = {f}^{*} ( X ) ;$$

In the above formulas, p represents a two-dimensional spatial location in Rᵢ; n=|Rᵢ|; η represents a learning rate; l represents a classification loss; \tilde{Y}ₗ represents a ground truth of a sampled HSI; Ŷₗ represents the predicted probability cube; a mapping f*:R^{C×H×W}→R^{#class×H×W} represents a patch-free model; and C represents a quantity of frequency bands of an input X.

In this embodiment, the mapping f* replaces an explicit patch with an implicit acceptance domain of a model, thereby avoiding the redundant computation in the overlapping region and obtaining a broader potential spatial context.

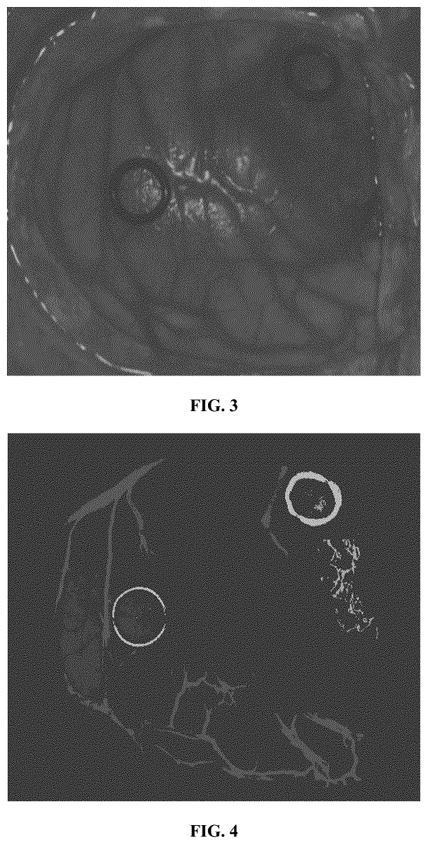

FIG. 3 is taken as an example. An image contains 826 wavebands, 127 noise wavebands are removed, and 699 wavebands are retained. The image has a size of 443×479 and a spatial resolution of 128.7 μm. A real label figure mainly contains three tissue categories and one type of background. Quantities of labeled pixels for different categories are shown in Table 1.

TABLE 1
Quantity of labeled samples

| | | Quantity of pixels for each type of label | | | | |
|---|---|---|---|---|---|---|
| HIS | Total | Normal | Tumor | Vascular | Back- | |
| dataset | pixels | tissue | tissue | tissue | ground | Total |
| 12-01 | 443 × 479 | 4516 | 855 | 8697 | 1685 | 15753 |

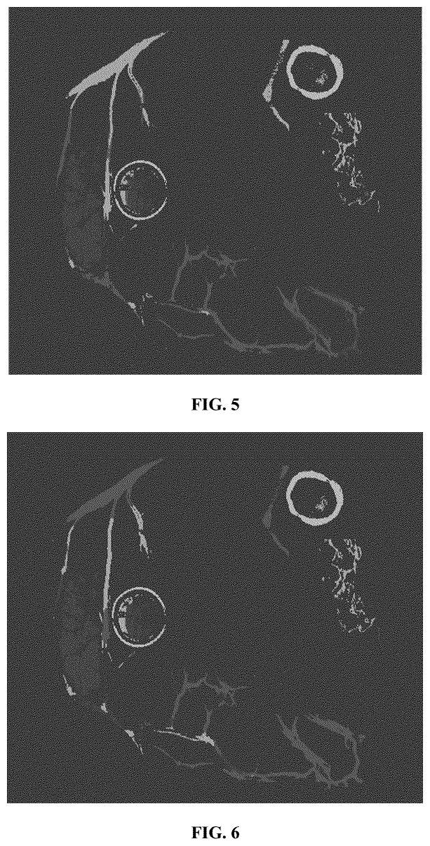

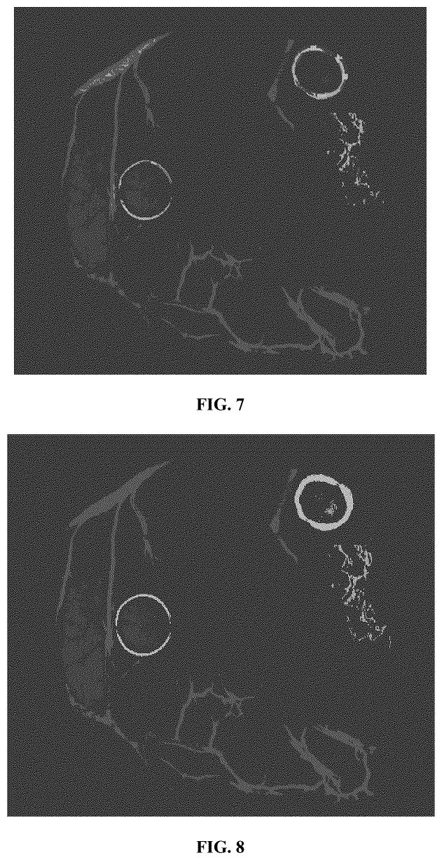

As shown in FIG. 5 to FIG. 8 and Table 2, compared with SVM, JNN, and JSR algorithms, the method provided in the embodiments of the present disclosure can achieve higher classification accuracy and stability.

TABLE 2
Classification accuracy and computation time

Method

| Evaluation indicator | SVM | JNN | JSR | FCN |
|---|---|---|---|---|
| Kappa coefficient | 0.6655 | 0.7543 | 0.7900 | 0.8844 |
| Overall accuracy | 76.84 | 83.84 | 87.25 | 92.84 |
| (%) | | | | |

Although the embodiments of the present disclosure are described with reference to the accompanying drawings, those skilled in the art may make various modifications and variations without departing from the spirit and scope of the present disclosure. These modifications and variations shall fall within the scope defined by the claims.

What is claimed is:

1. A medical hyperspectral image (MHSI) classification method based on a fast fully convolutional network (FCN), comprising:
preprocessing and sampling an MHSI to obtain a training sample set;
inputting the training sample set into an encoder-decoder-based FCN to train the MHSI; and
inputting a to-be-classified pixel of the MHSI into a trained encoder-decoder-based FCN to obtain a classification result.

2. The MHSI classification method based on a fast FCN according to claim 1, further comprising:
sampling a test sample for the MHSI; and
evaluating classification accuracy of the classification result based on the test sample.

3. The MHSI classification method based on a fast FCN according to claim 1, wherein the preprocessing and sampling an MHSI to obtain a training sample set comprises:
de-noising the MHSI by using a two-dimensional singular spectrum analysis (SSA) method.

4. The MHSI classification method based on a fast FCN according to claim 1, wherein the inputting the training sample set into an encoder-decoder-based FCN to train the MHSI method comprises:
converting the training sample set into a fixed quantity of channel outputs by using a backbone block;
sampling the training sample set by using a first hybrid block, to obtain a plurality of first eigenvalues; performing one-dimensional convolution on the first eigenvalues once to obtain a first one-dimensional convolution result; and performing two-dimensional convolution on the first one-dimensional convolution result once to obtain a first two-dimensional convolution result;
sampling the first two-dimensional convolution result by using a second hybrid block, to obtain a plurality of second eigenvalues; performing one-dimensional convolution on the second eigenvalues once to obtain a second one-dimensional convolution result; and performing two-dimensional convolution on the second one-dimensional convolution result once to obtain a second two-dimensional convolution result;
sampling the second two-dimensional convolution result by using a third hybrid block, to obtain a plurality of third eigenvalues; performing one-dimensional convolution on the third eigenvalues once to obtain a third one-dimensional convolution result; and performing two-dimensional convolution on the third one-dimensional convolution result once to obtain a third two-dimensional convolution result;
performing one-dimensional convolution on the third two-dimensional convolution result once by using a fourth hybrid block, to obtain a fourth one-dimensional convolution result; and performing two-dimensional convolution on the fourth one-dimensional convolution result once to obtain a fourth two-dimensional convolution result;
aggregating the first two-dimensional convolution result, the second two-dimensional convolution result, the third two-dimensional convolution result, and the fourth two-dimensional convolution result by using a decoder network, to restore a spatial detail of the input training sample set;
performing, by using a head subnetwork, pixel classification on a top-level feature aggregated by the decoder network to obtain a training classification result;
calculating a loss function for the training classification result; and
updating a weight of the encoder-decoder-based FCN through backpropagation based on the loss function,
wherein the first hybrid block, the second hybrid block, the third hybrid block, and the fourth hybrid block perform convolution calculation by using a convolutional block attention module (CBAM).

5. The MHSI classification method based on a fast FCN according to claim 4, further comprising:
connecting a first refinement module of the decoder network to the fourth hybrid block through a first convolutional layer of lateral connection-based semantic-spatial fusion (SSF) to transmit the fourth convolution result to an encoder network;
connecting a second refinement module of the decoder network to the third hybrid block through a second convolutional layer of the lateral connection-based SSF to transmit the third convolution result to the encoder network;
connecting a third refinement module of the decoder network to the second hybrid block through a third convolutional layer of the lateral connection-based SSF to transmit the second convolution result to the encoder network; and
connecting the head subnetwork of the decoder network to the first hybrid block through a fourth convolutional layer of the lateral connection-based SSF to transmit the first convolution result to the encoder network.

6. The MHSI classification method based on a fast FCN according to claim 5, wherein the calculating a loss function for the training classification result comprises:
minimizing the loss function of the training classification result by using a stochastic gradient descent method.

7. The MHSI classification method based on a fast FCN according to claim 5, wherein the aggregating the first two-dimensional convolution result, the second two-dimensional convolution result, the third two-dimensional convolution result, and the fourth two-dimensional convolution result by using a decoder network, to restore a spatial detail of the input training sample set comprises:
connecting the first refinement module and the second refinement module through a first upsampling module to aggregate the fourth two-dimensional convolution result and the third two-dimensional convolution result;
connecting the second refinement module and the third refinement module through a second upsampling module to aggregate the fourth two-dimensional convolution result, the third two-dimensional convolution result, and the second two-dimensional convolution result; and
connecting the third refinement module and the head subnetwork through a third upsampling module to aggregate the fourth two-dimensional convolution result, the third two-dimensional convolution result, the second two-dimensional convolution result, and the first two-dimensional convolution result.

8. The MHSI classification method based on a fast FCN according to claim 4, wherein the head subnetwork is constituted by a 3×3 convolutional layer and a 1×1 convolutional layer with N filters, wherein N is a quantity of categories.

9. The MHSI classification method based on a fast FCN according to claim 4, wherein the updating a weight of the encoder-decoder-based FCN through backpropagation based on the loss function comprises:
for an i^{th} iteration, updating a k^{th} weight of the encoder-decoder-based FCN as follows:
$${ω}_{i + 1}^{( k )} = {ω}_{i}^{( k )} - η \frac{1}{n} {\sum }_{p ∈ {R}_{i}} \frac{\partial l ( {\tilde{Y}}_{l} ( p ) , {\hat{Y}}_{l} ( p ) )}{\partial {ω}_{i}^{( k )}} ; \\ {\hat{Y}}_{l} = {f}^{*} ( X ) ;$$
wherein p represents a two-dimensional spatial location in Rᵢ; n=|Rᵢ|; q represents a learning rate; l represents a classification loss; \tilde{Y}ₗ represents a ground truth of a sampled HSI; Ŷₗ represents a predicted picture; a mapping f*:R^{C×H×W}→R^{#class×H×W} represents a patch-free model; and C represents a quantity of frequency bands of an input X.

10. The MHSI classification method based on a fast FCN according to claim 5, wherein the convolutional layer of the lateral connection-based SSF is as follows:
$${q}_{j + 1} = {q}_{j} + conv ( {p}_{4 - j} ) ;$$
wherein qⱼ represents a feature mapping of a #j refinement stage in a decoder; p₄₋ⱼ represents a feature mapping of a #4-j hybrid block in an encoder; qⱼ₊₁ represents an output of a convolutional layer of SSF; and j=1, 2, 3.
